(19) United States
(12) Patent Application Publication
(10) Pub. No.: US 2024/0247992 A1
(43) Pub. Date: Jul. 25, 2024

(54) PRESSURE GAUGE AND PRESSURE SENSOR HOUSING FOR A PROCESS STREAM

(71) Applicant: Custom Sensors & Technology, Fenton, MO (US)

(72) Inventors: Thomas M. Kornblum, Pevely, MO (US); Michael Ponstingl, Villa Ridge, MO (US); James Nation, St. Louis, MO (US)

(21) Appl. No.: 18/101,504

(22) Filed: Jan. 25, 2023

(51) Int. Cl. G01L 19/00

(52) U.S. Cl. CPC G01L 19/0038; G01L 19/0084

(57) ABSTRACT

A pressure gauge, and particularly a housing or fitting for a pressure sensor which provides for reduced cost of construction of any portion which is to be disposed of between batches. The pressure gauge will typically be comprised of two components which are interconnected in a self-aligning fashion. However, the bore carrying fluid for pressure measurement is confined to a single of these components.

### BACKGROUND OF THE INVENTION

### Field of the Invention

The invention relates to a pressure gauge and specifically a pressure gauge formed of a pressure sensor in a two-part housing or fitting which two parts self-align. Only one part of the housing contacts the process stream and the housing encloses the pressure sensing electronics. This can provide a pressure gauge which can be less expensive to construct.

### Description of the Related Art

There are a number of places where material production or activity creates what is effectively a process stream. Continuous manufacturing techniques as well as processes which are continuously acting on elements create a near constant output of end product or at least do so within a batch of production. An example of a process stream is in bioprocess fluid streams used in the manufacture of biological materials. However, many activities in chemical, petro-chemical, pharmaceutical, waste processing, food, and beverage manufacturing process, among many others, involve the monitoring of process streams which are producing end product.

Working with process streams generally requires that a series of actions be taken in accordance with a specific sequence and under particular conditions to insure that the manufacturing of the product in the stream occur in a known and expected fashion. As the output of these processes can be extraordinarily valuable, it is important that characteristics of the stream be known at all times during the processing so that any variations in the process stream can be known and accounted for either upstream or downstream of the measurement. In a large number of process stream applications, knowledge of the pressure within the hollow tubing carrying the fluid forming the process stream is a necessary piece of information.

In the production of biopharmaceuticals, measuring pressure accurately is often essential. In order to measure pressure in a fluid stream which is being carried in the flexible tubing which is common in such processes, an in-line pressure gauge is typically used. The in-line pressure gauge has traditionally mounted the pressure sensor within a fitting that includes an inlet and outlet port to allow the process stream to pass into the pressure gauge (which acts as a part of the fluid path), detect the pressure of the portion of the stream within the pressure gauge, and then exhaust the stream back into tubing. The ports include connectors for connecting to the appropriate tubing used in the process and the fitting is effectively simply placed within an appropriate place in the tubing and effectively becomes part of the fluid handling pathway of the process.

In biochemical manufacture, it is typical that the fluid handling pathway be maintained in a manner that there is minimal microbial contamination. Specifically, an uncontaminated environment has to be maintained throughout the process. Thus, the process stream is typically sealed from the external environment. Further, in order to avoid contamination between different batch runs within the process, the fluid handling pathway often needs to be sterile, or at least completely clean, before each run. Because of the difficulty in cleaning the inside of small diameter tubing, this has traditionally meant that the tubing used to carry the process stream, and the various sensors and devices attached to it and which have the process stream pass through them, are disposed of between batches. Thus, a large variety of components which are used in such process stream applications are typically disposed of after every batch. This disposal can includes storage containers, tubing, filters, and connectors. It has also typically included process sensors, such as the pressure gauge.

While pressure sensors and the associated electronics and electronic connectors can be made relatively inexpensively, there is no question that a pressure sensor and associated microelectronics, even if created simply to transmit the signal from the sensing element to a remote computer that is more expensive, is more expensive to construct than a simple piece of tubing. The cost is further exaggerated since, as the process stream passes into the pressure gauge to be measured, the pressure gauge housing has needed to be manufactured of medical grade material, made in a manner that allows sterilization and cleaning, and provided in such a state initially to the end user. Thus, any structural modification of a pressure gauge which allows it to be constructed less expensively, or allows for not all of the pressure gauge to be manufactured in a medical grade manner, can provide significant benefits and cost savings over time.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, there is a need for a pressure gauge, and particularly a the housing or fitting for a pressure sensor which provides for reduced cost of construction of any portion which is to be disposed of between batches. The pressure gauge will typically be comprised of two components which are interconnected in a self-aligning fashion. However, the bore carrying fluid for pressure measurement is confined to a single of these components.

There is described herein, among other things, a pressure gauge comprising: a fitment, the fitment comprising: a hollow bore therethrough; a first connector in-line with the hollow bore for allowing fluid to enter the hollow bore; a second connector in-line with the hollow bore for allowing fluid to exit the hollow bore; and an access arranged generally perpendicular to the hollow bore; pressure sensing electronics, the pressure sensing electronics including: a pressure sensor positioned in the access and recessed from the hollow bore; and a connector pin for electrically connecting the pressure sensor to an external electrical device; a mount, the mount including: a socket for physically connecting the pressure gauge to the external electrical device; and a base attached to the socket; wherein, the base is attached to the fitment by at least one thread forming screw; and wherein, as the base is attached to the fitment by the at least one thread forming screw, the base self-aligns with the fitment.

In an embodiment of the pressure gauge, the fitment is constructed of a different material from the mount.

In an embodiment of the pressure gauge, fluid in the hollow bore does not contact the mount.

In an embodiment, the pressure gauge further comprises a circuit board supporting the pressure sensing electronics.

In an embodiment of the pressure gauge, the circuit board is held in place in a chamber in the fitment from pressure applied by the base when the base is attached to the fitment.

In an embodiment of the pressure gauge, the socket is designed to interface with a Molex™ connector.

In an embodiment of the pressure gauge, the fitment further comprises a pillar extending therefrom, the pillar including a hole therethrough.

In an embodiment of the pressure gauge, the mount further comprises a recess extending thereinto, the recess including a hole in a wall thereof.

In an embodiment of the pressure gauge, the pillar mates with the recess.

In an embodiment of the pressure gauge, one of the at least one thread forming screw passes through the hole in the pillar and the hole in the wall of the recess.

In an embodiment of the pressure gauge, the pillar mating with the recess serves to self-align the mount with the fitment.

In an embodiment of the pressure gauge, the fitment further comprises a second pillar extending therefrom, the second pillar also including a hole therethrough; the mount further comprises a second recess extending thereinto, the second recess also including a hole in a wall thereof; and a second of the at least one thread forming screw passes through the hole in the second pillar and the hole in the wall of the second recess.

### BRIEF DESCRIPTION OF THE DRAWINGS

FIG. 1 shows a perspective view of an embodiment of a pressure gauge housing.

FIG. 2 shows a perspective view of a pressure gauge formed of the housing of the embodiment of FIG. 1 with pressure sensing electronics included therein.

FIG. 3 shows a top view of FIG. 2.

FIG. 4 shows a ghost view of FIG. 2 illustrating the pressure sensing electronics therein.

FIG. 5 shows a cut through view of the side of FIG. 2 to illustrate relative locations of the pressure sensing electronics and the internal volumes.

FIG. 6 shows a top perspective view of the fitment portion of the housing of FIG. 1 to better illustrate the internal volumes of FIG. 5.

### DETAILED DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

For purposes of clarity, it should be recognized that terminology when it comes to small sensors can be somewhat fluid. For example, when one refers to a “pressure gauge” or “pressure sensor” it should be recognized that such term can refer to both a macro scale object, but also, and more accurately, a component thereof. Specifically, a “pressure sensor” is usually simply a small electronic device which is sensitive to changes in pressure and produces a different electrical signal (or modifies an applied signal) when exposed to different pressures.

However, for such a pressure sensor to carry out such pressure measurements, it typically needs to be placed in contact with the fluid on which it is to take pressure measurements and access to the fluid often is through the form of a housing for the pressure sensor which is designed to transport some of the fluid to the pressure sensor and then return it to the process stream. This housing is further typically designed to be placed in-line with other fluid handling apparatus that handle the process stream. Thus, a “pressure sensor” in common parlance can sometimes be used to mean the pressure sensor; the pressure sensor, associated electronics, and the housing as a whole; or any combination of these things.

In the present discussion, in order to help resolve potential ambiguity around the term “pressure sensor” and other such terms this discussion will generally use the following terminology. A “pressure sensor” will generally be used to refer to the actual piece of material which a change in pressure effects. In many respects, this is a traditional pressure transducer or more generally a force collector. It may also have some associated electronic structures (e.g. wiring, circuits, or interconnects) that are necessary for it to function in this role.

“Pressure sensing electronics” will be the pressure sensor along with any additional associated electronics which allow the pressure sensor to produce a coherent electronic signal which is, in some capacity, indicative of a pressure amount or change, and to transmit those signals to some form of processor. Finally, a “pressure gauge” in this disclosure will be the pressure sensing electronics (including the pressure sensor) along with a housing which is designed to be placed into a system to provide access to the fluid upon which a pressure measurement will be taken by the pressure sensor.

In the present disclosure, the primary environment on which pressure measurements are being taken comprises the pressure of a fluid process stream which is enclosed within a contained volume flowing through tubing or piping. In order to expose the pressure sensor to the fluid in the tubing, the pressure sensor will be placed into a housing which includes a fitting for exposure of the pressure sensor to the stream by directing the stream, or a portion thereof, into itself. Pressure sensing by the pressure sensor will occur when the fluid is within the housing. The housing will also typically include sufficient additional pressure sensing electronics to allow for the generation of an electrical signal which can be sent from the resultant pressure gauge to an external electronic device or processor. This is often a general purpose computer running software, or a dedicated hardware processor, designed for such interpretation. The pressure gauge may measure static or dynamic pressure depending on the provided pressure sensor and pressure sensing electronics as well as any attached processors.

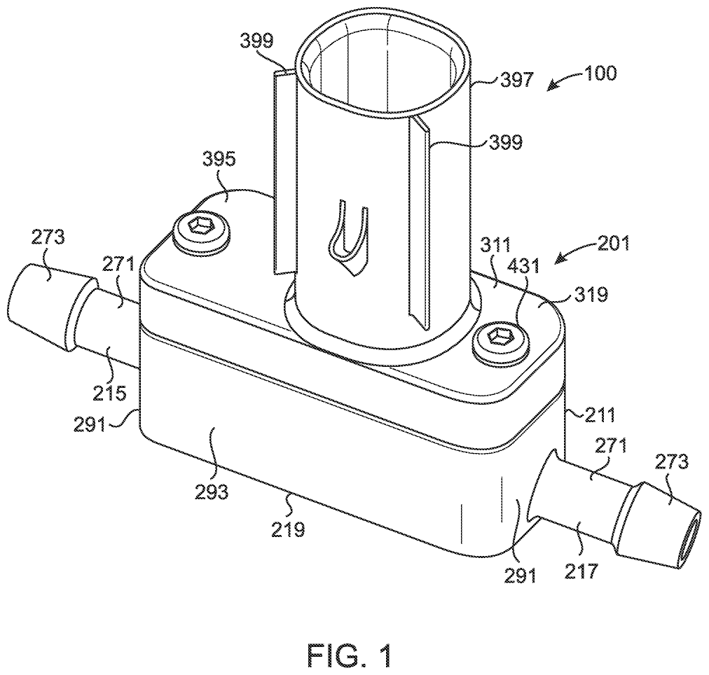

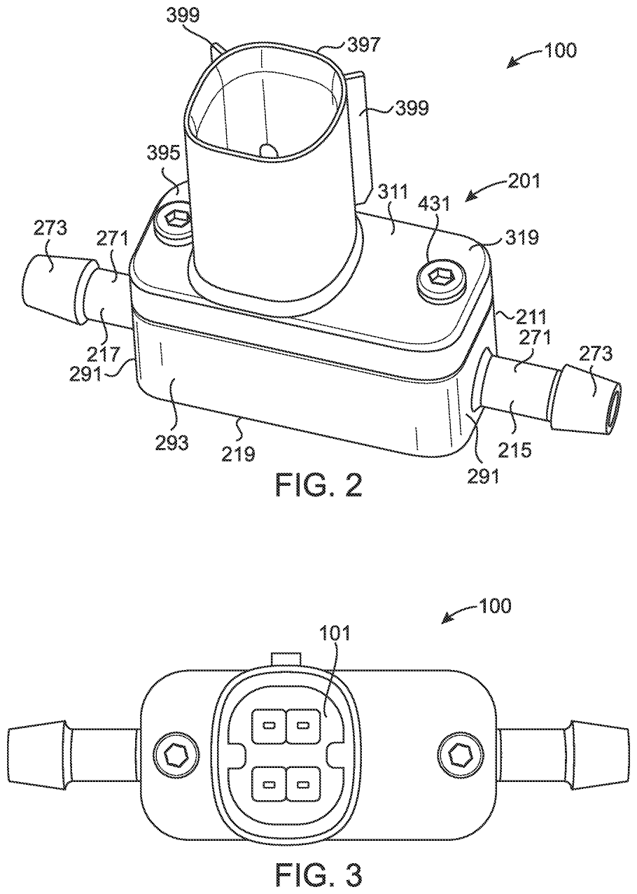

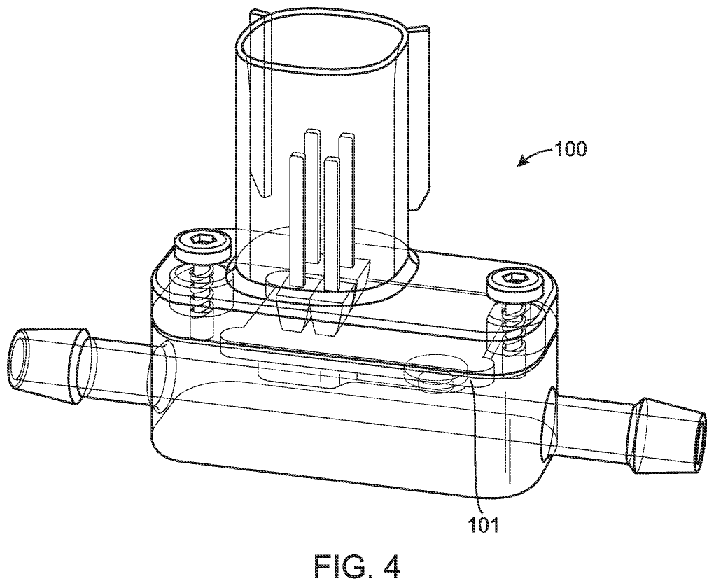

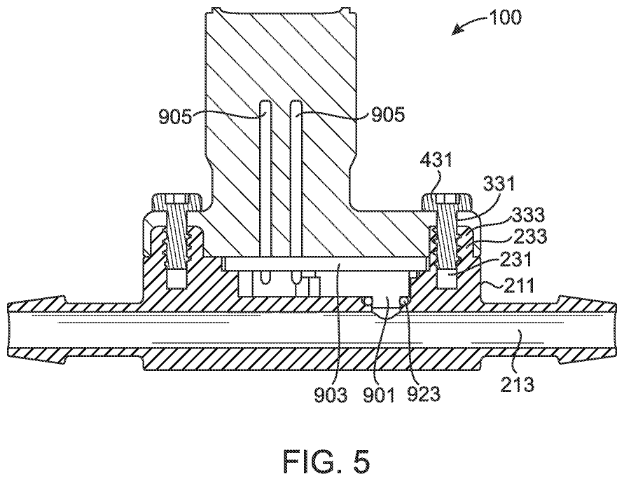

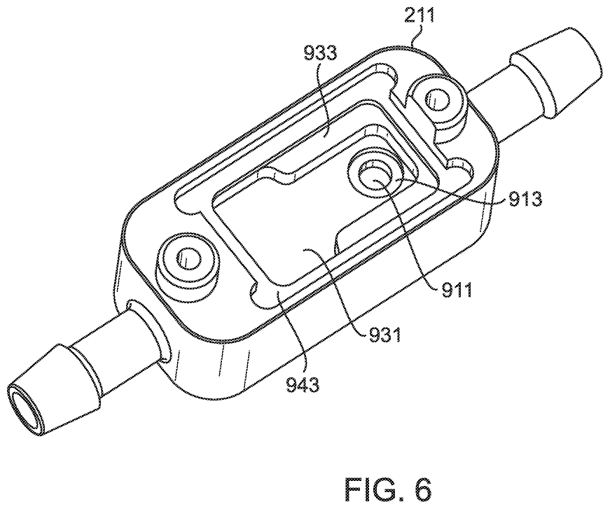

FIGS. 1-6 provide for various images of an embodiment of a pressure gauge (100) and components thereof. FIG. 1 provides an image of the housing (201) of the pressure gauge (100) without any pressure sensing electronics (101) therein while FIGS. 2 and 3 show the housing with the pressure sensing electronics (101) therein. FIGS. 4 and 5 provide ghost and cut-away images respectively of the pressure gauge (100) to better show positioning of the pressure sensing electronics (101) within the housing (201). FIG. 6 provides a view of the fitment (211) portion of the housing (201) with the mount (311) and pressure sensing electronics (101) removed to better show internal structure of the fitment (211).

The housing (201) is generally designed to house and enclose the pressure sensor (901) and associated pressure sensing electronics (101) and allow the pressure sensor (901) to measure the pressure within a process stream that is passing through the fitment (211) portion of the housing (201) via the hollow bore (213). As can be best seen in FIGS. 1 and 2, the housing (201) in this embodiment is constructed of two major pieces which are the fitment (211) and the mount (311) which are connected together to form the housing (201) that holds the pressure sensing electronics (301) therein. The fitment (211) and mount (311) are designed to generally self-align with each other so that assembly of the housing (201) is simplified and consistent.

The fitment (211) is designed primarily to carry the portion of the process stream upon which the pressure sensor (901) is to take measurements and to support the pressure sensor (901) in a positon where it can take such measurements. The fitment (211) includes a body structure (219) with two tubing connectors (215) and (217) attached thereto. The body structure (219) in the embodiments of the FIGS. is generally in the form of a rectangular prism with rounded edges, but that is by no means required. The tubing connectors (215) and (217), as best shown in FIGS. 1 and 6 extend from the shorter faces (291) of the body structure (219) as opposed to the longer faces (293) and are generally parallel with the major plane of the body structure (219) but, again, such arrangement is not required.

Each of the tubing connectors (215) and (217) is generally in the form of a elongated cylinder (271) with an extended cuff (273) generally in the form of a conical frustum with the wider base arranged at the end of each cylinder (271). This arrangement forms each of the connectors (215) and (217) into the shape of a barbed hose connector as that term would be generally understood by one of ordinary skill in the art. Barbed hose connectors are a well-known and common form of connector for interfacing with flexible tubing. This form for tubing connector (215) and (217) is valuable in many smaller process stream applications such as in the production of biopharmaceuticals as it is a common form of connector to tubing used in such systems. It is, however, not the only form of tubing connector (215) or (217) that may be used and other forms of tubing connector (215) or (217) may be used in alternative embodiments.

The tubing connectors (215) and (217) may also come in a variety of lengths and diameters depending on the nature of the connection to be made, the process stream, or other considerations. Similarly, the body structure (219) may be a variety of sizes and the diameter and length of the bore (213) may also be altered based on similar considerations. Still further, the tubing connectors (215) and (217) may be replaced by other forms of connectors if the pressure gauge (100) is to be connected to or within a different system including if the process stream and/or if fluid was to be provided to the hollow bore (213) via a different process. Thus, the structure of tubing connectors (215) and (217) is by no means a required form of connector and other connectors may be used in alternative embodiments.

Within the internal volume of the fitment (211) there is a hollow bore (213) which extends through both the connectors (215) and (217) and through the body structure (219). The hollow enclosed bore (213) will typically be generally in the form of a cylindrical opening which will extend from the top of each of the tapered frustums (273) through each cylinder (271) and through the body structure (219) in a generally linear fashion. However, the linearity is not required and in alternative embodiments a different path of the hollow enclosed bore (213) may be used. The diameter of the hollow bore may also alter within the connectors (215) and (217) and/or body structure (219). The body structure (219) and connectors (215) and (217) will typically be integrally formed from a single monolithic piece of material (e.g. machined via traditional negative manufacture from a single piece of source material), but this is not required and these elements may be assembled from separate components.

As can be best seen in FIG. 6, there is an access (911) which is positioned in the body structure (219) and which has an axis generally perpendicular to the major axis of the hollow bore (213). The access (911) is in fluid communication with the hollow bore (213). This will typically be the only place within the body structure (219) where fluid in the hollow bore (213) could leave the bore (213) except that the access (911) will be blocked by the pressure sensor (901) and the sealing ring (923) as contemplated later. Thus, fluid which would enter the bore (213) via one connector (215), travels along the confined path of the bore (213) and past the access (911) to the other connector (217) without contacting any surface except the external walls of the bore (213) which are formed of the body structure (219) and connectors (215) and (217) and the pressure sensor (901) and possibly the sealing ring (923) in the access (911).

Attached to the top of the body structure (219) when the housing (201) is formed is the mount (311). The mount (311) is typically designed to support and align various electronic components of the pressure sensing electronics (101) within the housing (201). In particular connection of the mount (311) to the fitment (211) will typically serve to hold the pressure sensing electronics (101) in position and encase them within the housing (201). The mount (311) also provides for a physical connection point for interconnection of the pressure sensing electronics (101) via a cable and mating connector to an external computer, processor, or other device for interpreting signals produced by the pressure sensing electronics (101). This allows the signals produced by the pressure sensor (901) to ultimately be interpreted by a human user, or to be used by other electronics as desired in the process being monitored by the pressure gauge (100).

The mount (311) is generally formed of a base (319) which is also generally in the form of a rectangular prism with rounded edges of similar dimensionality to the fitment (211) so as to sit generally flush on a major surface of the body structure (219). The base (319) is typically of reduced width compared to the body structure (219) as it will act as more of a cap to hold the pressure sensing electronics (101) (and particularly the circuit board (903)) in place through pressure. Importantly, the mount (311) does not include any portion of the bore (213) therethrough. Thus, fluid in the bore (213) will have no contact with the mount (311).

Extending from the top major surface (395) of the base (319) is a socket (397). The socket (397), as best shown in FIG. 2, is designed to interface with the physical (as opposed to electrical) connection components of additional attached electronics. In the depicted embodiment, the socket (397) is configured to interconnect to a standard four pin Molex™ MX150 connector and, thus, includes protrusions (399) which are designed to interface with such a connector in the manner understood by one of ordinary skill in the art.

In the depicted embodiment, the socket (397) is arranged to extend generally perpendicularly from the major surface of the base (319) as shown. This positioning corresponds to the positioning of the pins (905) to allow interconnection of the pressure gauge (100) with a Molex™ or similar connector when the pins (905) are mounted on the circuit board (903) as shown in FIGS. 4 and 5. In alternative embodiments, this arrangement is not required and the socket (397) may be arranged to extend from the base (319) at an alternative angle. This angle can position the major axis of the socket (397) generally parallel to the major surface of the base (319) while also allowing for rotation about the base (319) (e.g. within the plane of the sockets (397) major axis in this arrangement). The socket (397) can also extend any direction where the major axis of the socket (397) is at any angle between parallel and perpendicular with the major plane of the base (319). At any of these angles, the socket (397) can again be rotated about the base (319). These alternative arrangements will typically require that the pins (905) be moved or attached to the circuit board (903) in a different fashion so that the pins (905) are correctly positioned in the socket (397) to make electrical connection or indirectly as would be understood by one of ordinary skill in the art. However, such alternative designs can meet necessary space or design constraints outside the scope of this disclosure.

The base (319) further includes two recesses (333) each of which includes a hole (331) through a wall (in the depicted embodiment, it would typically be called the end) thereof. The recesses (333) are designed to act as a female connector and engage and mate with corresponding pillars (233) which extend from the body structure (219) and act as the corresponding male connector when the base (211) and mount (311 are interconnected). Each of the pillars (233) also includes a hole (231) which runs through it's structure. Holes (331) and holes (231) are designed to be engaged by screws (431).

When the pillars (233) and recesses (333) are aligned, the hole (331) in each recess (333) is aligned with corresponding hole (231) in the mating pillar (233) in the body structure (219). Thus, when the base (319) is placed on the body structure (219) the pillars (233) and recesses (333) will mate and the corresponding holes (231) and (331) will be aligned in a generally linear fashion. This will also typically serve to self-align the fitment (211) with the mount (311). The screws (431) can then be placed through the holes (331) typically engaging the material of the base (319) and pass through those holes (331) into holes (231) also engaging the material of the body structure (219). The screws (431) are generally thread forming screws of a type known to those of ordinary skill in the art which are intended to interconnect and securely hold the base (319) and body portion (219) together and aligned and to allow the mount (311) to press into the body portion (219) of the fitment (211) to sandwich the circuit board (903) between the base (319) and body portion (219). The holes (331) and (231) are generally not pre-threaded prior to the screw (431) insertion to assist with the self-alignment of the mount (311) with the fitment (211) and avoid existing threads not being correctly aligned.

The fitment (211) and mount (311) will typically be constructed of two different materials but that is by no means required. Specifically, the fitment (211) will typically be machined using negative manufacture from a solid piece of material as indicated above. As such, it may be manufactured of any traditional material and my be designed to withstand high pressure within the enclosed bore (213). Further, the bore (213) will often need to meet certain medical grade manufacturing requirements in material and quality, and the fitment (211) may need to be sterilized via chemical or heat treatment should the pressure gauge (100) be used in biomedical manufacturing processes. Thus, the fitment (211) material may be selected to meet any or all of these requirements.

However, as should be apparent from the structure discussed above, the mount (311) does not have any contact with the process stream in the enclosed bore (213) and, thus, does not need to meet these same requirements. Instead, the mount (311) is simply used to hold the pressure sensor (901) in place in the fitment (211) (typically via the circuit board (903) being sandwiched between the mount (311) and the fitment (211) in the hollow chamber (931)) and to allow for easy interconnection of external electronics via the socket (397). Thus, the mount (311) will typically have no need to withstand pressure within the hollow bore (213) and, as it will not contact the process stream, typically has no need to be sterilized or of medical grade. Thus, the mount (311) may be constructed inexpensively and easily. In the depicted embodiment, the mount (311) may be 3D printed using any appropriate material.

FIGS. 2-5 provide for depictions showing how the pressure sensing electronics (101) are placed within the housing (201) and sandwiched between the mount (311) and fitment (211). The pressure sensing electronics (101) will generally comprise a circuit board (903) and the pressure sensor (901) which extends from a circuit board (903). The pressure sensor (901) will extend into an access (911) which enables pressure detection within the enclosed bore (213). A portion of the pressure sensor (901) may, thus, be in contact with the fluid in the enclosed bore (213) or may be connected to a component which is. For example, in an embodiment, the access (911) may be sealed from the bore (213) by a cap or similar structure which can transmit the pressure to the pressure sensor (901) which would be enclosed in the hollow chamber (931). In such an embodiment, the pressure sensor (901) would actually be fluidly sealed from the bore (213) via the cap in the access (911) instead of the pressure sensor (901) itself acting to seal the access (911) from the bore (213).

There will typically be a surrounding depression (913) around the access (911) and that portion of the pressure sensor (901) that extends into the access (911). The depression (913) will serve to provide a position to hold a seal (923) about the access (911) which serves to seal the hollow bore (213) from the rest of the pressure sensing electronics (101). This seal (923) serves to both promote accurate pressure measurement and to keep the circuit board (903) from contacting the process stream in the enclosed bore (213).

In the depicted embodiment, the depression (913) is generally cylindrical and is designed to hold an “O-ring” seal (923) made of a compressible material suitable for the given fluid to which the pressure gauge (100) is to be exposed. In an alternative embodiment, the depression (913) may be in the form of an inverted conical frustum or other shape to accept an alternative shape of seal. In still further embodiments, alternative forms of the depression (913) may be used or depression (913) may be eliminated entirely if a seal can otherwise be formed to prevent process fluid from getting beyond the access (911). Typically, the seal (923) will be engaged by the pressure sensor (901) and held in place due to the compression imparted onto the pressure sensing electronics (101) by them being sandwiched between the fitment (211) and the mount (311).

Typically, the pressure gauge (100) will have the pressure sensor (901) recessed from the main flow of the process stream going through the hollow bore (213) by being retracted slightly into the access (911) toward the hollow chamber (931). This positions the pressure sensor (901) generally perpendicular to the flow of the process stream in the hollow bore (213) and because the pressure sensors sits in a slightly recessed position, the pressure sensor (901) senses the pressure tangentially to the flow of the process stream. This can help prevent mechanical occlusion of the pressure sensor (901) and the access (911) which, in turn, helps inhibit any unintended pressure drop which may occur across a pressure sensor (901) that would protrude into the hollow bore (213) and the process stream.

The circuit board (903) will generally include any necessary circuit electronics and connections which are a part of the pressure sensing electronics (101) and need to be provided prior to any external processing. These will generally simply enable the output of the pressure sensor (901) to be handled and transmitted from the pressure sensor (901) to the cable connector pins (905). Cable connector pins (905) are also a part of the pressure sensing electronics (101). The cable connector pins (905) in the depicted embodiment comprise electrically conductive pins (905) which are designed to electrically interconnect to the electrical interconnection components of a four-pin Molex™ MX150 connector. The connector pins (905) extend upward from the circuit board (903) into socket (397) as previously discussed. This will enable a mating connector which will typically be attached to a cable to engage connector pins (905) when plugged into socket (397).

Such interconnection will enable the signal from the pressure sensor (901) to be transmitted from the pins (905) to the cable and then to an attached computer or similar processing device for use. It is the case that the socket (397) is designed to be physically part of the housing (201) to avoid the need to include any cable attached directly to the circuit board (903) as this can reduce cost and complexity of manufacture. In an embodiment, the socket (397) may be engaged by a cable and connector leading to an external output conditioning module to provide initial processing of the signal from the pressure sensor (901) which may then be sent on by that output conditioning module for additional use.

Extra electronics on the circuit board (903) will typically be used to assist in pre-processing of the signal from the pressure sensor (901). Typically, pre-processing on the circuit board (903) will be kept to a minimum so as to not place any extra electronics on the circuit board (903) which are not strictly necessary to transfer the signal from the pressure gauge (901) through the pins (905). This allows for the circuit board (903) and, thus, the pressure sensing electronics (101), to be made as inexpensively as possible.

FIG. 6 provides additional detail of the space occupied by the circuit board (903) and pressure sensor (901) in the fitment (211). The circuit board (903) will typically rest on a support shelf (943) which extends around a hollow chamber (931) which includes the depression (913) and the access (911) in its base. There is also an internal shelf (933) which surrounds a portion of the hollow chamber (931) and is recessed further into the fitment (211) than the support shelf (933) which surrounds the hollow chamber (931).

In the depicted embodiment, the internal shelf (933) generally forms a “U” being on three sides of the chamber (931). On the fourth side, and partially on two of the attached sides, the chamber (931) does not include the internal shelf (933). The internal shelf (933) is generally sized and shaped to provide for a tight fit with the pressure sensor (901) on the circuit board (903) which extends downward into the chamber (931) as best shown in FIG. 5 and into the access (911). This typically will assist in securely engaging the pressure sensor (901) with the access (911) and seal (923).

The support shelf (943) is sized and shaped to mate with the circuit board (903) and the circuit board (903) will typically fit quite tightly into the space above the support shelf (943). However, the support shelf (943) will generally not be used for self-alignment of the fitment (211) with the mount (311) except in rough positioning. Instead, the circuit board (903) positioned on the shelf (943) will generally only loosely fit with more precise alignment being performed by the mating pillars (233) and recesses (333) and the screws (431) being positioned in holes (231) and (331). The arrangement of the mating pillars (233) and recesses (333) when screwed together will, thus, typically provide self-aligning of the fitment (211) and mount (311) and serve to sandwich the circuit board between the base (319) of the mount (311) and the top of the support shelf (943). The pressure sensor (901) will be partially engaged by the internal shelf (933) and extend into the access (911) engaging the seal (923) to seal the hollow chamber (931) from the bore (213).

The qualifier “generally,” and similar qualifiers as used in the present case, would be understood by one of ordinary skill in the art to accommodate recognizable attempts to conform a device to the qualified term, which may nevertheless fall short of doing so. This is because terms such as “perpendicular” are purely geometric constructs and no real-world component or relationship is truly “perpendicular” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. A pressure gauge comprising:
a fitment, the fitment comprising:
a hollow bore therethrough;
a first connector in-line with said hollow bore for allowing fluid to enter said hollow bore;
a second connector in-line with said hollow bore for allowing fluid to exit said hollow bore; and
an access arranged generally perpendicular to said hollow bore;
pressure sensing electronics, said pressure sensing electronics including:
a pressure sensor positioned in said access and recessed from said hollow bore; and
a connector pin for electrically connecting said pressure sensor to an external electrical device;
a mount, said mount including:
a socket for physically connecting said pressure gauge to said external electrical device; and
a base attached to said socket;
wherein, said base is attached to said fitment by at least one thread forming screw; and
wherein, as said base is attached to said fitment by said at least one thread forming screw, said base self-aligns with said fitment.

2. The pressure gauge of claim 1 wherein said fitment is constructed of a different material from said mount.

3. The pressure gauge of claim 1 wherein fluid in said hollow bore does not contact said mount.

4. The pressure gauge of claim 1 further comprising a circuit board supporting said pressure sensing electronics.

5. The pressure gauge of claim 4 wherein said circuit board is held in place in a chamber in said fitment from pressure applied by said base when said base is attached to said fitment.

5. The pressure gauge of claim 1 wherein said socket is designed to interface with a Molex™ connector.

6. The pressure gauge of claim 1 wherein said fitment further comprises a pillar extending therefrom, said pillar including a hole therethrough.

7. The pressure gauge of claim 6 wherein said mount further comprises a recess extending thereinto, said recess including a hole in a wall thereof.

8. The pressure gauge of claim 7 wherein said pillar mates with said recess.

9. The pressure gauge of claim 8 wherein one of said at least one thread forming screw passes through said hole in said pillar and said hole in said wall of said recess.

10. The pressure gauge of claim 9 wherein said pillar mating with said recess serves to self-align said mount with said fitment.

11. The pressure gauge of claim 10 wherein:
said fitment further comprises a second pillar extending therefrom, said second pillar also including a hole therethrough;
said mount further comprises a second recess extending thereinto, said second recess also including a hole in a wall thereof; and
a second of said at least one thread forming screw passes through said hole in said second pillar and said hole in said wall of said second recess.
